(19) United States
(12) Patent Application Publication
(10) Pub. No.: US 2005/0210019 A1
(43) Pub. Date: Sep. 22, 2005

(54) Method and apparatus for retrieving image from database, and computer product

(75) Inventors: Yusuke Uehara, Kawasaki (JP); Daiki Masumoto, Kawasaki (JP); Shuichi Shiitani, Kawasaki (JP); Susumu Endo, Kawasaki (JP); Takayuki Baba, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/124,107

(22) Filed: May 9, 2005

Related U.S. Application Data
(63) Continuation of application No. PCT/JP02/12135, filed on Nov. 20, 2002.

(51) Int. Cl. G06F 17/30

(52) U.S. Cl. 707/3

(57) ABSTRACT

An image retrieval apparatus includes an extracting unit that extracts a plurality of feature values from a key image, a determining unit that determines presence or absence of similarity based on whether the similarity fitted to the human's feeling regarding the similarity is calculated for the type of each feature, a calculating unit that calculates a similarity between the key image and each of a plurality of target images based on a result of determination obtained by the determining unit, and an selecting and outputting unit that selects and outputs image data that matches with the similarity calculated by the calculating unit.

### BACKGROUND OF THE INVENTION

1) Field of the Invention

The present invention relates to a technology for retrieving images from a database with one image as a key image.

2) Description of the Related Art

Image retrieval apparatuses have been developed that enable users to efficiently retrieve desired image data from an image database and display the retrieved image data. Precisely, the image database contains a large amount of image data and the image retrieval apparatuses retrieve from the image database image data that is similar to key image data, which is provided by a user, in an order of similarity, and display the retrieved image data.

These image retrieval apparatuses use the technology called the content-based (similarity) image retrieval. In other words, feature values, which numerically express prominent features of image data, of each of the image data in the image database are defined, and a feature value of the key image data is compared with the feature values of the image data in the image database to numerically calculate a similarity between the key image data and the image data in the image database. The calculated similarity is used to extract image data from the image database.

Various feature types are used depending on the characteristic feature that is to be recognized. The feature types include distribution of colors and texture in the image, a shape of outline of objects in the image, and the like.

Accordingly, many effective definitions and methods of extracting thereof are generally proposed to fit the human's feeling regarding the similarity for each type of feature. See, for example, Norio Katayama and Shinichi Sato: Index Technology for Similarity Retrieval, in the issue of Information Processing Society of Japan, vol. 42, No. 10, pp. 958 to 964 (2001).

Therefore, in conventional image retrieval apparatuses, various types of features are prepared beforehand and retrieval is performed based on a feature type that meets the purpose of the user.

However, it is difficult for users who not have sufficient knowledge regarding the feature type of images to decide a feature type to be used for retrieval process.

Accordingly, such users select the feature type based on trial and error basis. This necessitates repeating the process of the retrieve and it put a lot of burden is put on the users.

Additionally, to fit the similarity calculated by using the feature type to the human's feeling regarding the similarity, the content of the target image data should fulfill certain conditions which are defined for each type of the feature.

Therefore, if any image data which does not meet the purpose is included in the retrieval target, the calculated similarity is sometimes mismatched to the human's feeling so that an image data that the user eels significantly lacking of similarity to the key image is included in the retrieval result.

Such a problem does not occur if the image data targeted for the retrieval is limited only to the image data which fulfills conditions of the type of the feature to be used.

However, if image data collection in which various contents of image data such as image data collected by utilizing Internet recently widespread are mixed, is as the retrieval target, many image data which do not fulfill the condition of the type of the feature are included so that the retrieval accuracy is reduced.

### SUMMARY OF THE INVENTION

It is an object of the present invention to solve at least the problems in the conventional technology.

An image retrieval method according to an aspect of the present invention includes extracting a plurality of feature values from a key image; determining presence or absence of a compatibility for each of feature types of the feature values based on whether a similarity that matches with feelings of humans about similarity can be calculated for each of the feature types; calculating a similarity between the key image and each of a plurality of target images based on a determination result obtained at the determining; and selecting and outputting a target image from among the target images that matches with the similarity calculated at the calculating.

An image retrieval apparatus according to another aspect of the present invention includes an extracting unit that extracts a plurality of feature values from a key image; a determining unit that determines presence or absence of a compatibility for each of feature types of the feature values based on whether a similarity that matches with feelings of humans about similarity can be calculated for each of the feature types; a calculating unit that calculates a similarity between the key image and each of a plurality of target images based on a determination result obtained by the determining unit; and a selecting and outputting unit that selects and outputs a target image from among the target images that matches with the similarity calculated by the calculating unit.

A computer-readable recording medium according to still another aspect of the present invention stores a computer program that causes a computer to execute the above image retrieval method according to the present invention.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of an image retrieval apparatus according to an embodiment of the present invention;

FIG. 2 is an exemplary configuration of an image database shown in FIG. 1;

FIG. 3 an exemplary configuration of a feature value database shown in FIG. 1;

FIG. 4 is a flowchart of a process procedure performed by the image retrieval apparatus shown in FIG. 1;

FIG. 5 is a detailed flowchart of a feature value storage process shown in FIG. 4;

FIG. 6 is a detailed flowchart of a retrieval process shown in FIG. 4;

FIG. 7 is a detailed flowchart of a compatibility determination process shown in FIG. 6;

FIGS. 8A to 8D are schematics for explaining the retrieval process shown in FIG. 6;

FIGS. 9 to 11 are schematics for explaining the compatibility determination process of color layout feature according to the embodiment;

FIG. 12 is a drawing for explaining color layout feature;

FIG. 13 is an equation used for a compatibility determination of the color layout feature according to the embodiment;

FIGS. 14A and 14B are drawings for explaining the compatibility determination of texture feature according to the embodiment;

FIGS. 15A and 15B are drawing for explaining a compatibility determination of shape feature according to the embodiment;

FIG. 16 is a drawing of an exemplary retrieval results screen when the color layout feature is used;

FIG. 17 is a drawing of an exemplary retrieval results screen when the texture feature of is used;

FIG. 18 is a drawing of an exemplary retrieval results screen when the shape feature of is used; and

FIG. 19 is a block diagram of a modification of the embodiment.

### DETAILED DESCRIPTION

Exemplary embodiments of the present invention are described in detail with reference to drawings.

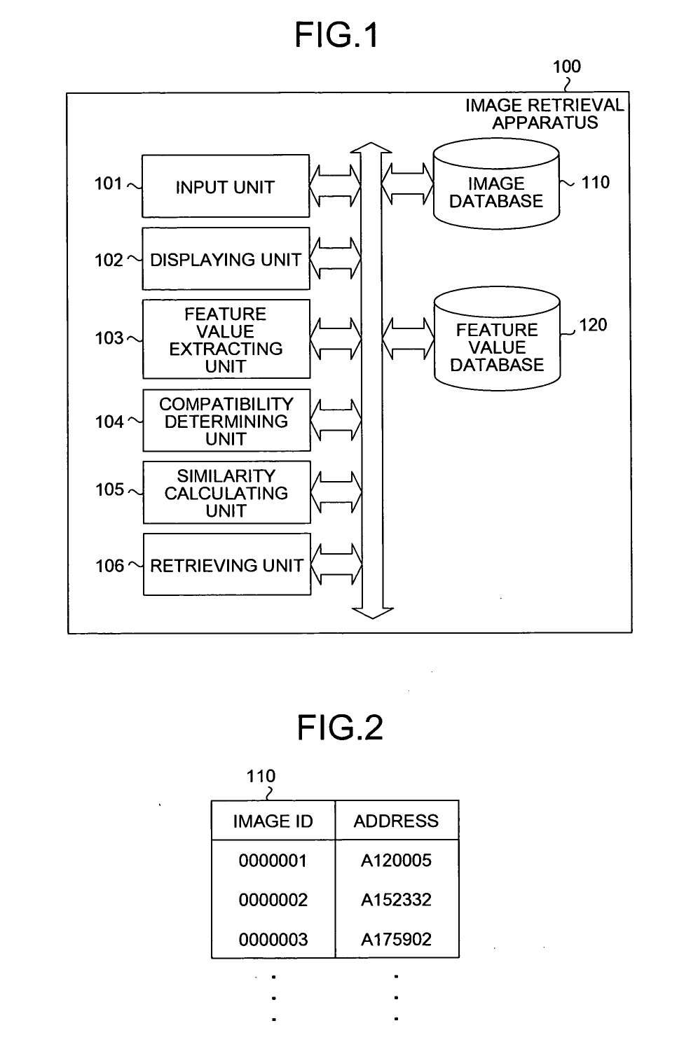

FIG. 1 is a block diagram of an image retrieval apparatus 100 according to an embodiment of the present invention.

The image retrieval apparatus 100 is an apparatus that selects the feature type having a high possibility to fit a human's feeling regarding the similarity among a plurality of types of feature (such as a color layout feature, a texture feature and a shape feature) used for calculating the similarity between a key data and an image dada in the after-described image database 110, and retrieve images by using the selected feature type.

In the image retrieval apparatus 100, an input unit 101 is an input device used for inputting the key image data as a retrieval key for the content-based image retrieval and for inputting various keys, which is such as a digital camera, a scanner, an Internet communication equipment, a key board, and a mouse.

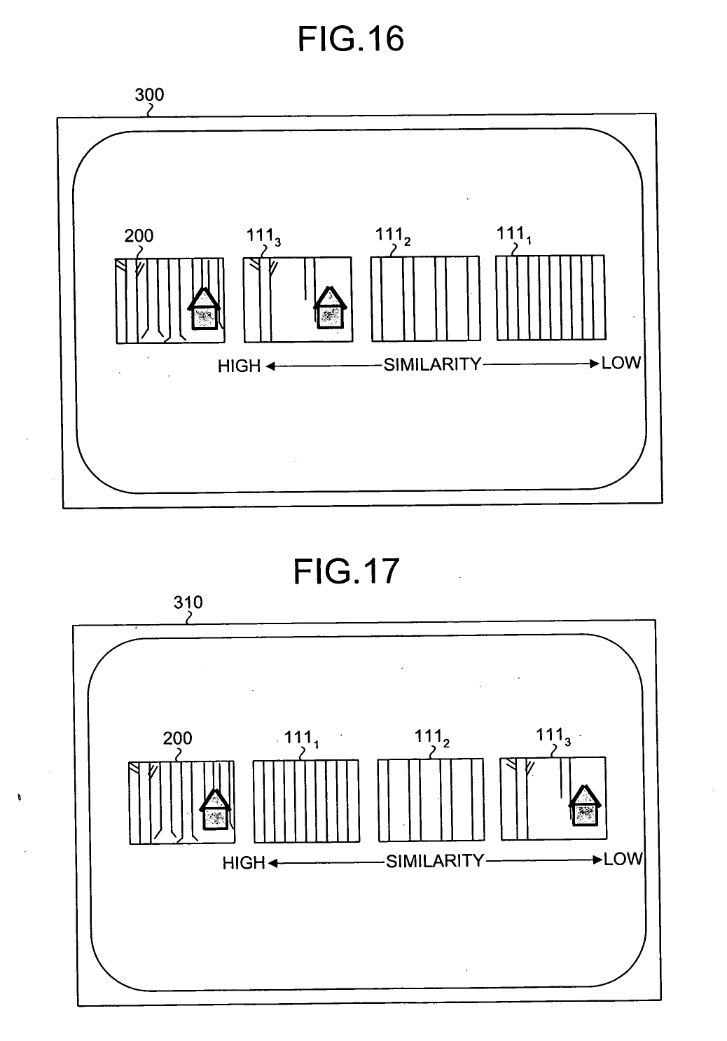

A displaying unit 102 can be a LCD (Liquid Crystal Display) and a CRT (Cathode Ray Tube). The displaying unit 102 displays to users a predetermined number of retrieval results (image data) in descending order of the similarity to the key image data through a retrieval results screen for the image retrieval (see FIG. 16 to FIG. 18).

The image database 110 is formed on a magnetic memory device or a semiconductor memory, which is a device to store image data as the retrieval target. Specifically, the image database 110 is provided with fields of an image ID and an address of FIG. 2. The image ID is an identifier to identify each image data as the retrieval target and the key image data. The address indicates locations where image data are actually stored.

For example, an image data whose image ID is “0000001” corresponds to an image data 111₁ targeted for the retrieval of FIG. 8B. The image data 111₁ represents a wall paper image in vertically striped pattern.

An image data whose image ID is “0000002” corresponds to an image data 111₂ targeted for the retrieval of FIG. 8C. The image data 111₂ represents a wall paper image in vertically striped pattern as well as the image data 1111.

An image data whose image ID is “0000003” corresponds to an image data 111₃ targeted for the retrieval of FIG. 8D. The image data 111₃ represents a photographic image of clump of trees and a house in a forest.

A feature value database 120 is a database to store feature value data that numerically expresses each feature in the image data (for example, the image data 111₁ to 111₃ (see FIG. 8A to 8D) that are stored in the image database 110 (see FIG. 2) and key image data (for example, the key image data 200 (see FIG. 8A)).

Now in the present embodiment, the following three varieties (1) to (3) are exemplified as types of features of images.
(1) color layout feature
(2) texture feature
(3) shape feature

The (1) color layout feature is a feature type representing a spatial distributed state of colors on the image data. The (2) texture feature is a feature type representing depictions to depict a pattern and a feel of a material in the image data. The (3) shape feature is a feature type representing the shape of the outline of an object in the image data.

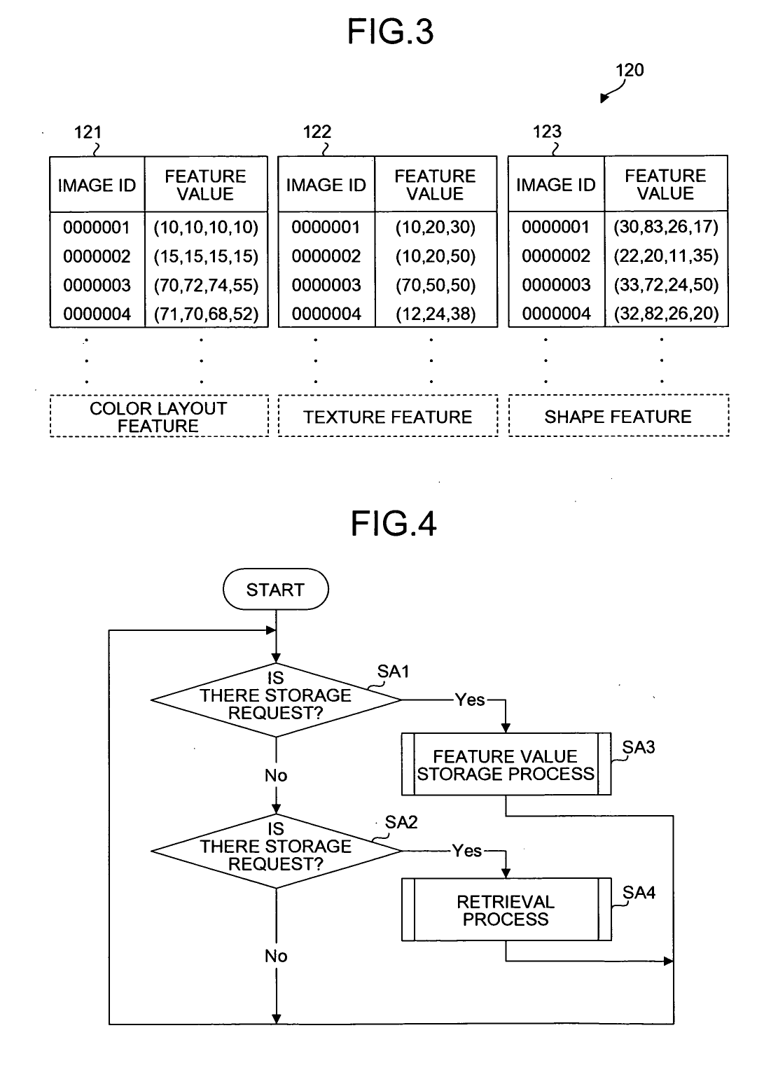

Specifically, the feature value database 120 is composed of a color layout feature value table 121, a texture feature value table 122 and a shape feature value table 123 as shown in FIG. 3.

Each of the color layout feature value table 121, the texture feature value table 122 and the shape feature value table 123 is provided with fields of the image ID and the feature value. The image ID corresponds to the image ID of the image database 110 (see FIG. 2).

The feature value of the color layout feature value table 121 indicates the color layout feature value regarding the image data which corresponds to the image ID. The feature value of the texture feature value table 122 indicates the texture feature value regarding the image data which corresponds to the image ID. The feature value of the shape feature value table 123 indicates the shape feature value regarding the image data which corresponds to the image ID.

Turning back to FIG. 1, a feature value extracting unit 103 extracts the feature value corresponding to the three types of feature (color layout feature, texture feature and shape feature), respectively from each image data targeted for the retrieval and key image data stored in the image database 110, and stores the extracted feature value in the feature value database 120 (see FIG. 4).

Those feature values are used for calculating a similarity between the key data and the image data targeted for the retrieval.

A compatibility determining unit 104 determines, for the type of feature value used for numerically calculating the similarity between the key data and the image data targeted for the retrieval, the presence or absence of the compatibility between the feature value and the given key image data based on whether the similarity fitted to a human feeling regarding the similarity is calculated when the similarity is calculated.

A similarity calculating unit 105 calculates the similarity of each image data targeted for the retrieval to the key image data based on Euclidean distance between a vector value corresponding to the feature value of the key image data determined to be compatible and a vector value corresponding to each image data targeted for the retrieval. A retrieving unit 106 performs a process regarding image retrievals.

Next, the operation of the present embodiment is described with reference to the flowcharts of FIG. 4 to FIG. 7. The image database 110 of FIG. 1 previously stored a plurality of image data targeted for the retrieval as shown in FIG. 2.

In this state, it is determined whether a request for storing the feature value from users is existence and the determination result is “No” at step SA1 of FIG. 4.

At step SA2, it is determined whether a request for the image retrieval from users is existence and the determination result is “No”. Subsequently, the determination of the step SA1 and the step SA2 is repeated until the determination result of the step SA1 or the step SA2 becomes “Yes”.

Then, when the user requests for storing the feature value, the determination result of the step SA1 is “Yes”. At step SA3, a feature value storage process to extract the feature value corresponding to the above described three types of feature (color layout feature, texture feature and shape feature) from the image data stored in the image database 110 and store the extracted feature value in the feature value database 120 is performed.

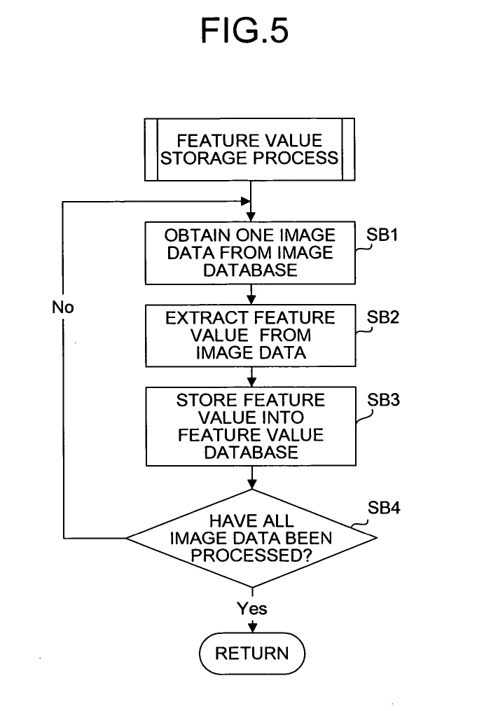

Specifically, at step SB1 of FIG. 5, the feature value extracting unit 103 obtains an image data (for example, image data 111₁ (see FIG. 8B) from the image database 110 (see FIG. 2). At step SB2, the feature value extracting unit 103 extracts the feature value corresponding to the three types of feature (color layout feature, texture feature and shape feature), respectively from the image data obtained in the step SB1.

Hereinafter a method of extracting the feature value corresponding to the color layout feature, the texture feature and the shape feature, respectively is described in detail.

Color Layout Feature

First, a method of extracting the feature value corresponding to the color layout feature is described.

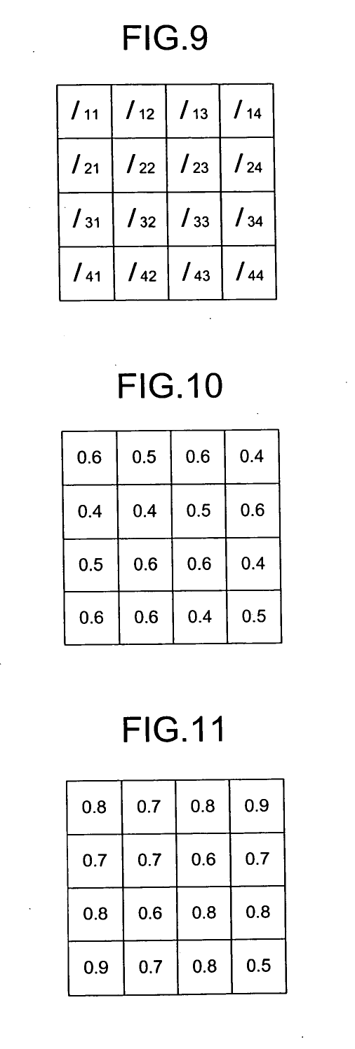

The color layout feature value is represented as one-dimensional arranged values of the averaged color value of each partial image data Iᵢⱼ for example as shown in FIG. 9. The partial image data Iᵢⱼ are made by dividing vertically and horizontally the image data into an appropriate number in a lattice arrangement.

Where, the averaged color value of the partial image data Iᵢⱼ is represented by a three-dimensional vector composed of the intensity of R (red), G (green) and B (blue) in the RGB color space.

When the averaged color value of the of the partial image data Iᵢⱼ is (Rᵢⱼ, Gᵢⱼ and Bᵢⱼ), the color layout is represented as (R₁₁, G₁₁, B₁₁, R₁₂, G₁₂, B₁₂, and R₄₄, G₄₄, B₄₄).

To take the color layout on the meaning, a predetermined number or more partial image data which satisfy the following two conditions (1A) and (1B) are required:
Condition (1A): The image data contains a color by a certain value or more ratio, and
Condition (2A): The pixels having the color which satisfies the condition (1A) should spatially concentrate.

The conditions (1A) and (2A) indicate that the averaged color value of the partial image data approaches to the overall color of its partial image data.

For example, if the image data contains many colors by bits, the averaged color value is not very approached.

Alternatively, in case of the image data contains a color by a certain ratio or more, when the color is divided into small regions and dispersed, the color is not felt as the striking color by human. Therefore, the pixels should be spatially concentrated in the image data.

Whether the image data satisfies the condition (1A) and (2A) is determined by the following method.

Determination Method of the Condition (1A)

First, the RGB space is divided into the partial color spaces. Then, the number of pixels contained in the partial image data in each partial color space is counted, then, the ratio value between the total pixel number of the partial image and the pixel number of the counted result is calculated for each partial color space.

If there is the partial color space in which the ratio value is equal to or more the predetermined value, the color value being representative of the partial color space is determined as the representative color for its partial image.

As to a method of determining the representative color of a partial image, there is the method by which a color positioned at the center-of-mass in the corresponding to partial color space is the representative color. If there is the representative color of the partial image, the condition (1A) is satisfied.

Determination Method of the Condition (2A)

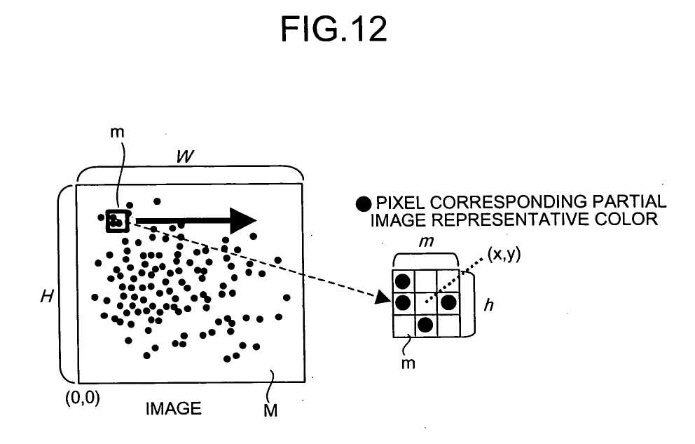

As to the representative color of the partial image obtained by the determination process of the condition (1A), the concentration ratio is calculated by the following method. Firstly, all of the pixels on the partial image M are allocated w×h sized windows m such that each pixel is centered in the window m as shown in FIG. 12. Then, the pixel number RC_{xy} corresponding to the representative color of the partial image in the window m is counted.

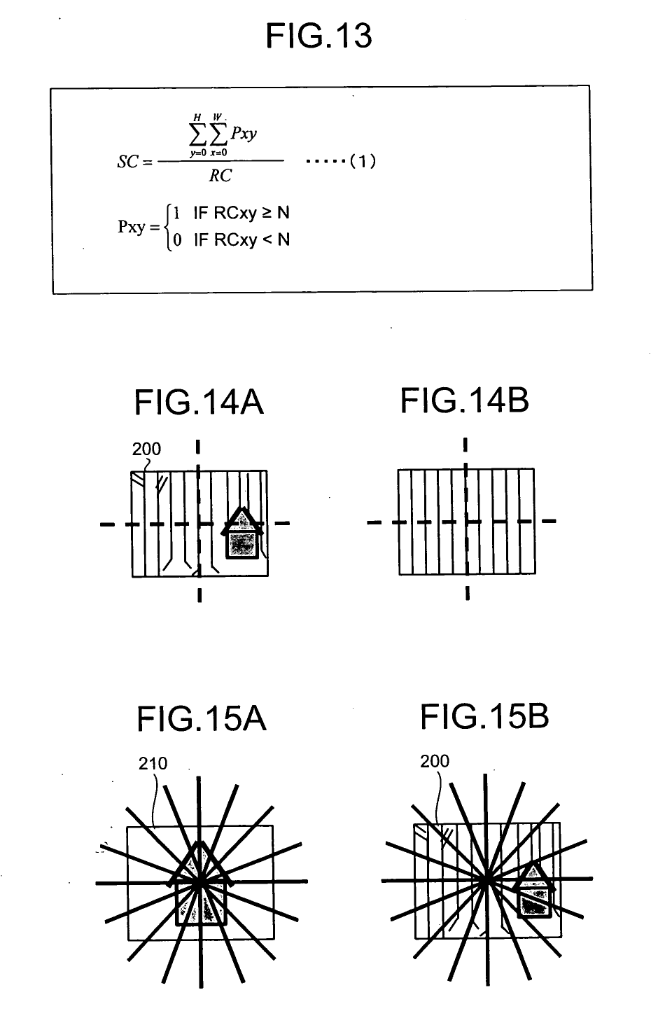

At this time, a concentration ratio SC is calculated using the equation (1) shown in FIG. 13. Where, RC is the total number of the pixels corresponding to the representative color of the partial image, and N is the predetermined value.

If the concentration ratio SC has the representative color more than the predetermined value, the condition (2A) is satisfied.

Texture Feature

The method of extracting the feature value corresponding to the texture feature is described below.

In general, the feature value corresponding to the texture feature is extracted based on the premise that the image data is entirely covered with the uniform texture (pattern). Therefore, if the image data is not covered with the uniform texture, the feature value may not be surely extracted.

Accordingly, when the key image data that is not covered with the uniform texture is the given as a target for the image retrieval, the image data that an ordinary person feels to be not similar to the key image data indicates higher similarity than the image data that the ordinary person feels to be similar.

If the result of the image retrieval is displayed in descending order of the similarity, the image data the ordinary person feels to be not similar is disadvantageously ranked higher than the image data the ordinary person feels to be similar to the key image data, which leads to a decrease in the retrieval efficiency.

For example, a key image data 200 of FIG. 8A as the key image for the image retrieval is provided, while the retrieval targets are the image data 111₁, 111₂, and 111₃ of FIGS. 8B, 8C, and 8D.

The key image data 200 and the image data 111₃ are the photographic image of a scene including a house in the clump of trees. The image data 111₁, and 111₂ correspond to the wall paper image covered with the uniform texture.

The texture feature value is calculated by the well-known Tamura's method (H. Tamura, S. Mori and T. Yamawaki, “Texture Features Corresponding Visual Perception,” IEEE Trans. System Man and Cybernetics, vol. 8, No. 6, (1978).)

In Tamura's method, the texture feature value is indicated by three components of “coarseness”, “contrast” and “directionality”, and extracted as a three-dimensional vector which numerically expresses the ratio of each component from the image data.

The “coarseness” represents the scale of the pattern in the image data, and the more the scale is large, the more the value becomes large. The “contrast” represents the ratio of the dispersion of luminance, and the more the scale is large, the more the value becomes large.

The “directionality” represents the ratio of concentration of the edge components in the image data in a certain direction, and the more the frequency in the direction which is the highest frequency among the direction of the edge components is high, the more the value becomes large.

If the feature value corresponding to the texture feature is extracted from the key image data 200 (see FIG. 8A) using Tamura's method, the key image data 200 indicates higher similarity to the image data 111₁ and the image data 111₂ than the image data 111₃ in any of the coarseness, the contrast and the directionality.

However, if the user retrieves a scene image in the image retrieval, it is inappropriate that the image data 111₁ and the image data 111₂ are included in the retrieval result. If such inappropriate data is ranked higher, users have to view more unnecessary image data to find the objective image data so that the retrieval efficiency is decreased.

Therefore, for such key image data, the uniformity of texture is calculated and if the uniformity is less than the predetermined value, it is determined that the key data is not compatible and not used for the retrieval.

Now, the method of calculating the uniformity of texture is described. Firstly, the image targeted for the calculation is divided vertically and horizontally. For example, the image data (such as the key image data 200) is partitioned into four regions divided vertically and horizontally in half as shown in FIGS. 14A and 14B.

Next, the texture feature is extracted from each divided partial image as the vector. At this time, the method of calculating the texture feature may be same as the method of calculating the feature for the calculation of the similarity, and the other method may be applied.

Where, if the Tamura's method as well as the described above is used, the feature of the three-dimensional vector is extracted from each partial image. The uniformity of the texture is represented by the degree of the dispersion of the extracted feature vector.

The more the texture is uniformed, the less the vector is dispersed. Thus, for the four feature vectors obtained from the partial images, the dispersion value is calculated as the degree of the dispersion. If the dispersion value is larger than the predetermined value, the uniformity is low, that is to say, it is determined not to be compatible. For example of FIG. 14A, if key data 200 is used, the partial image on the bottom right is significantly different from the other three in terms of the coarseness, the contrast and the directionality so that it can be determined not to be compatible.

Shape Feature

Next, the method of extracting the feature value corresponding to the shape feature is described.

As to the method of extracting the feature value corresponding to the shape feature, there are the method in which the outline is previously extracted and the method in which the outline is not extracted. If the image data collected from Internet are used, most of them are not previously extracted the outline, therefore, the latter method is used.

Meanwhile if an arbitrary image data is targeted, it is technologically difficult to extract the outline of the object in the image. Therefore, the shape feature is approximately represented as the frequency distribution of the local edge components for each direction by utilizing the fact that the outline of the object becomes a sharp edge component.

The method of extracting the feature value corresponding to such shape feature is based on the premise that the following condition (3A) is satisfied.

Condition (3A): The background is a monochrome, and any object exists in a specific portion of the image data.

The specific portion is such as near center location of the image data.

The method of determining the compatibility based on the condition (3A) is as follows.

Firstly, the pixels are scanned in the direction toward the center of the image data along radial lines extended from the center of the image data at every predetermined angle as shown in FIGS. 15A and 15B.

The difference between the luminance value of continued pixels is sequentially calculated during scanning, and the coordinate value (x, y) of the point where the difference is more than the predetermined value is stored.

For the coordinate value obtained from the results of the above described process for each scanning line, the distance between the adjacent scanning lines each other is multiplied. The multiplication value is as reference value, and if it is larger than the predetermined value, the data is determined not to be compatible. In the case of an image data 210 which satisfies the condition as FIG. 15A, the stored distance between the coordinate values is reduced.

Meanwhile, as to a key image data 200 of FIG. 15B, any one other than the object (house) is drawn in the background. If the feature value is extracted from such image, a significant shape feature can not be obtained by the affect of outlines other than the object.

Such image data can be determined not to be compatible because the stored distance between the coordinate values is relatively increased.

Returning to FIG. 5, at step SB3, the feature value extracting unit 103 stores each feature type (color layout feature, texture feature and shape feature) extracted in the step SB2 in the feature value database 120 (see FIG. 3).

At step SB4, the feature value extracting unit 103 determines whether all the image data in the image database 110 are processed (extract and store the feature data). In this case, the determination result is “No”. Subsequently, the above described process is applied to the remaining image data.

When the process is completed, the determination result of the step SB4 is “Yes” and the feature value storage process is completed.

Then, if a request for the image retrieval from users, the determination result of the step SA2 in FIG. 4 is “Yes”. In the step SA4, a retrieval process to retrieve the image data being similar to the key image data is performed.

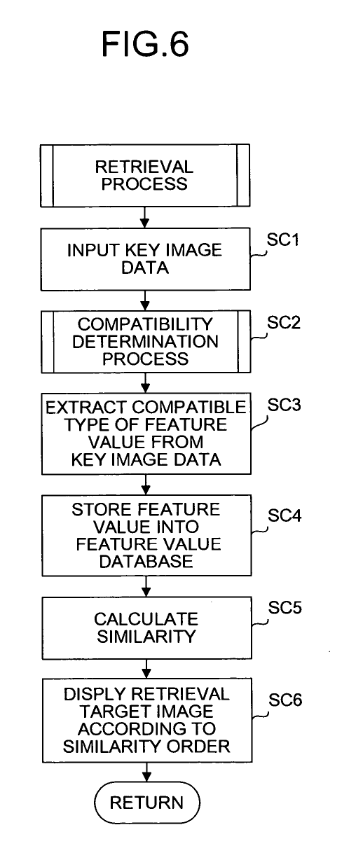

Specifically, at step SC1 of FIG. 6, users input the key image data 200 of FIG. 8A through the input unit 101. The key image data 200 corresponds to the photographic image which is taken the same location as the image data 111₃ of FIG. 8D at the different angle.

In the step SC2, for the key image data 200, the compatibility determination process to determine the compatibility to each of the color layout feature, the texture feature and the shape feature is performed.

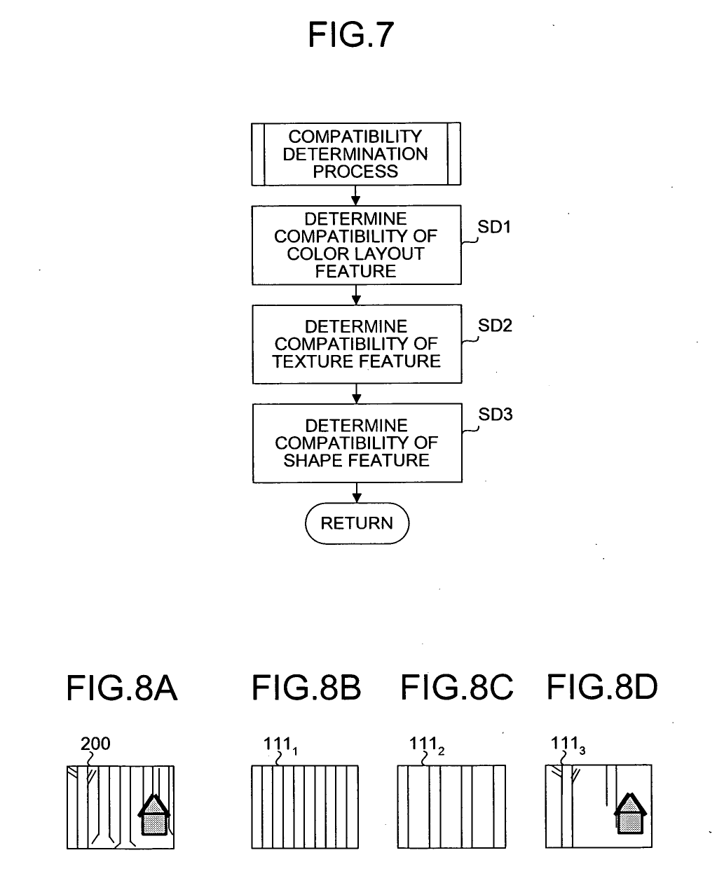

Specifically, at step SD1 of FIG. 7, the compatibility determining unit 104 determines the compatibility of the layout feature. That is to say, the compatibility determining unit 104 divides the image data 200 vertically and horizontally.

Where, the key image data 200 is partitioned into sixteen partial image data (I₁₁ to I₄₄) divided vertically and horizontally in quarters as shown in FIG. 9.

Next, the compatibility determining unit 104 calculates the ratio value of the number of pixels included in each partial color space when R, G and B are divided in quarters, respectively for each partial image (I₁₁ to I₄₄), and evaluates the ratio value of the partial color space which has the maximum ratio value as the value indicated in the FIG. 10.

Where, the ratio value takes the range [0.0, 1.0] and the larger the value is, the higher the ratio is.

For the color layout feature, if the threshold ratio value to be the representative color of the partial image in the above described method of determining the condition (1A) is 0.3, all of the partial images have the partial color space with the ratio value higher than the threshold value, and also have the representative color of the partial image.

Additionally, if the concentration ratio SC of the representative color of the partial image with the ratio value of FIG. 10 is calculated by setting N of the equation (1) (see FIG. 13) to evaluate the concentration ratio SC in the method of determining the condition (2A) of the color layout feature to six, the result is the value indicated of FIG. 11 for example. The concentration ratio SC takes the range [0.0, 1.0] and the more the value is large, the more the concentration ratio is high.

Where, if the threshold value SC in the method of determining the condition (2A) of the color layout feature is 0.6, the partial images other than the partial image on the bottom-right of FIG. 11 has the concentration ratio higher than the threshold value so that the partial images satisfy the condition (2A). That is to say, the partial image on the bottom-right does not satisfy the condition (2A).

Finally, if the threshold value of the partial image number which satisfies both of the condition (1A) and the condition (2A) being the reference to determine the compatibility to the color layout feature is fourteen, the key image data 200 satisfies both the condition (1A) and the condition(2A) for the fifteen partial images except for the partial image on the bottom-right so that it is determined to be compatible with the color layout feature.

At step SD2 of FIG. 7, the compatibility determining unit 104 determines the compatibility of the texture feature. That is to say, the compatibility determining unit 104 partitions the key image data 200 into four regions divided vertically and horizontally in half, and extracts the texture feature as the vector value from each partial image.

Next, the compatibility determining unit 104 calculates the dispersion values between each vector value as 0.7 for example.

Where, the dispersion values take the range [0.0, 0.1], and the more the value is large, the more the dispersion is enlarged.

If the threshold value for the dispersion value to determine the compatibility between the key image data 200 and the texture feature is 0.6, the dispersion image data 200 is equal to or more than the threshold value. Therefore, in this case, the key image data 200 do not have the uniformity of the texture so that it is determined not to be compatible with the texture feature.

At step SD3 of FIG. 7, the compatibility determining unit 104 determines the compatibility of the shape feature. That is to say, as shown in FIGS. 15A and 15B, the pixels are scanned in the direction toward the center of the image along radial lines extended from the center of the key image data 200 at every angle of 22.5 degree.

The compatibility determining unit 104 sequentially calculates the difference between the luminance value of continued pixels during scanning, and stores the coordinate value (x, y) of the pixel where the difference is more than the predetermined value. The threshold value of the difference is 0.8 if the range of the difference value is [0.0, 1.0] for example.

For the coordinate value obtained from the results of the above described process for each scanning line, the distance between the adjacent scanning lines each other is multiplied, and the multiplication result is 1150 for example. Where if the threshold value for the multiplication value is 1000, the key image data 200 has the multiplication value larger than the threshold value so that it is determined not to be compatible.

Accordingly, it is determined that the key image data is compatible with the color layout feature, but is not compatible with the texture feature and the shape feature.

Turning back to FIG. 6, in the step SC3, the feature value extracting unit 103 extracts the feature value corresponding to the compatible type (in this case, it is the color layout feature) from the key image data 200.

In the step SC4, the feature value extracting unit 103 homologizes the extracted feature value (color layout feature) in step SC3 with a image ID (=0000004) corresponding to the key image data 200 and stores the homologized data in color layout feature value table 121 (see FIG. 3).

The feature value corresponding to the image ID (=0000004)s are stored in the texture feature value table 122 and the shape feature value table 123 in FIG. 3, however, those are not stored actually.

At step SC5 of FIG. 6, the similarity calculating unit 105 obtains the feature value (the color layout feature of the key image data 200) corresponding to the image ID (=0000004) from the color layout feature value table 121 of FIG. 3. The feature value corresponds to the type (color layout feature) determined to be compatible with the key image data 200 in the step SC2.

Next, the compatibility determining unit 104 determines whether the above described type (color layout feature) and each image data targeted for the retrieve stored in the image database 110 are compatible.

Specifically, the compatibility determining unit 104 determines the presence or absence of the compatibility between the color layout feature and each image data as well as the step SD1 of FIG. 7.

If the type is the texture feature, the compatibility determining unit 104 determines the presence or absence of the compatibility between the texture feature and each image data as well as the step SD2 of FIG. 7.

If the type is the shape feature, the compatibility determining unit 104 determines the presence or absence of the compatibility between the shape feature and each image data as well as the step SD3 of FIG. 7.

Next, the similarity calculating unit 105 excludes the image data determined no to be compatible by the compatibility determining unit 104 among all of the image data targeted for the retrieval and narrows down the retrieval target to the image data determined to be compatible (for example, the image data corresponding to image ID (=0000001, 0000002 and 0000003)).

Next, the similarity calculating unit 105 obtains the feature value (color layout feature of the image data 111₁, 111₂ and 111₃) corresponding to the image ID (=0000001, 0000002 and 0000003).

Then, the similarity calculating unit 105 calculates Euclidean distance between the feature value (color layout feature) corresponding to the key image data 200 and the feature value (color layout feature) corresponding to the key image data 111₁, 111₂ and 111₃, respectively. After two places of decimals counts fractions over ½ as one and disregarding the rest and the result (Euclidean distance) is as follows:
Key image data 200 and Image data 111₁: 111.6
Key image data 200 and Image data 111₂: 101.7
Key image data 200 and Image data 111₃: 7.1

On the above result, the more Euclidean distance is short, the more the similarity between the key image data 200 and the image data targeted for the retrieval is high.

Accordingly, the ranking of the similarity to the key image data 200 (color layout feature) is that the first is the image data 111₃ (see FIG. 8D), the second is the image data 111₂ (see FIG. 8C) and the third is the image data 111₁ (see FIG. 8B).

At step SC6 of FIG. 6, the retrieving unit 106 obtains the image data 111₃, the image data 111₂ and the image data 111₁ as the result of retrieval from the image database (see FIG. 2) in the similarity order evaluated in the step SC5.

Next, the retrieving unit 106 makes the displaying unit 102 display the retrieval result screen 300 of FIG. 16. The retrieval result screen 300 displays the retrieval result when the color layout feature is used, and the key image data 200, and the image data 111₃, image data 111₂ and image data 111₁ in the high similarity order are displayed in left-to-right.

As shown in the retrieval result screen 300, the image data 111₃ (landscape picture) which is felt more similar to the key image data 200 (landscape picture) by human is displayed at the highest position and the image data 111₂ and the image data 111₁ which are not felt similar are displayed behind the image data 111₃.

Where, if the image retrieval is performed by using the feature value corresponding to the texture feature without the above described compatibility determination, the feature value (texture feature) stored in the texture feature value table 122 (see FIG. 3) is used. Euclidean distance between the key image data 200 and the image data targeted for the retrieval (image data 111₁, 111₂ and 111₃) is following:
Key image data 200 and Image data 111₁: 9.2
Key image data 200 and Image data 111₂: 12.8
Key image data 200 and Image data 111₃: 64.7

Accordingly, the ranking of the similarity to the key image data 200 (texture feature) is that the first is the image data 111₁ (see FIG. 8B), the second is the image data 111₂ (see FIG. 8C) and the third is the image data 111₃ (see FIG. 8D).

In this case, the retrieving unit 106 makes the displaying unit 102 display the retrieval result screen 310 of FIG. 17. The retrieval result screen 310 displays the retrieval result when the texture feature is used, and the key image data 200, and the image data 111₁, image data 111₂ and image data 111₃ in the high similarity order are displayed in left-to-right.

As shown in the retrieval result screen 310, the image data 111₁ which is not felt similar by human to the key image data 200 (landscape picture) is displayed at the highest position and the image data 111₃ which is felt more similar is displayed at the lowest similarity position.

Where, if the image retrieval is performed by using the feature value corresponding to the shape feature without the above described compatibility determination, the feature value (shape feature) stored in the shape feature value table 123 (see FIG. 3) is used. Euclidean distance between the key image data 200 and the image data targeted for the retrieval (image data 111₁, 111₂ and 111₃) is following:
Key image data 200 and Image data 111₁: 3.7
Key image data 200 and Image data 111₂: 66.3
Key image data 200 and Image data 111₃: 31.7

Accordingly, the ranking of the similarity to the key image data 200 (shape feature) is that the first is the image data 111₁ (see FIG. 8B), the second is the image data 111₃ (see FIG. 8D) and the third is the image data 111₂ (see FIG. 8C).

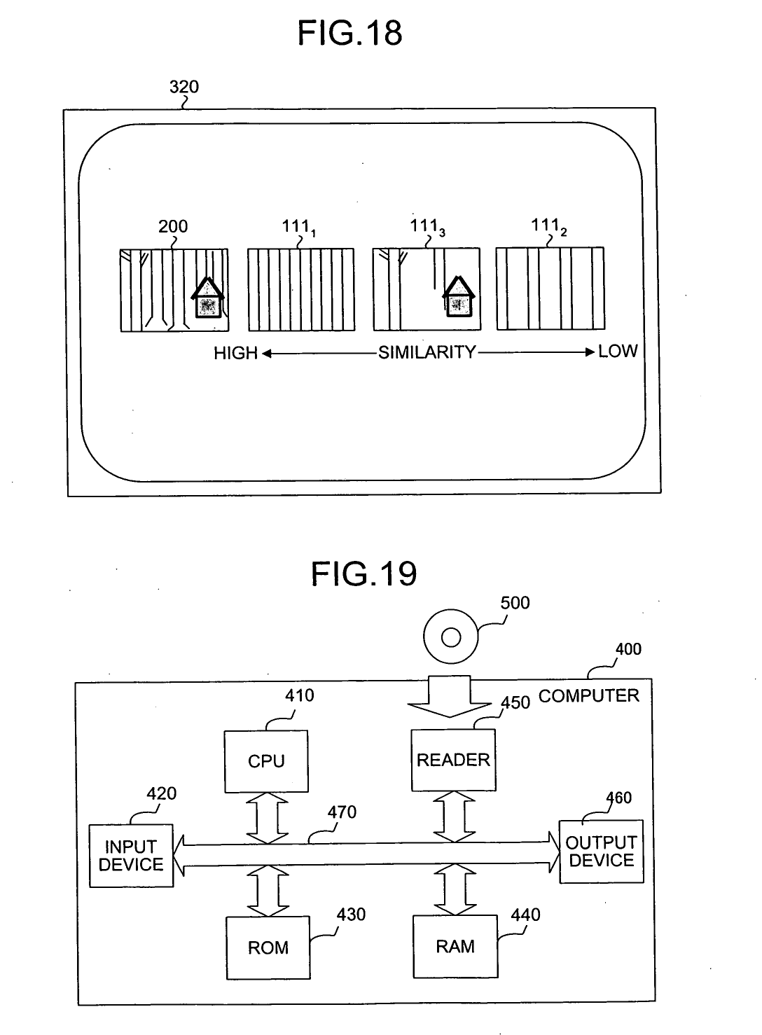

In this case, the retrieving unit 106 makes the displaying unit 102 display the retrieval result screen 320 of FIG. 18. The retrieval result screen 320 displays the retrieval result when the shape feature is used, and the key image data 200, and the image data 111₁, image data 111₃ and image data 111₁ in the high similarity order are displayed in left-to-right.

As shown in the retrieval result screen 320, the image data 111₁ which is not felt similar by human to the key image data 200 (landscape picture) is displayed at the highest position and the image data 111₃ which is felt more similar is displayed at the middle similarity position.

As thus described above, according to the present embodiment, for each type of the feature (color layout feature, texture feature and shape feature) extracted from the key image data 200, the presence or absence of the compatibility is determined based on whether the similarity fitted to the human's feeling regarding the similarity is calculated, the similarity between the key image data 200 and each image data targeted for the retrieval is calculated according to the determined result, and the image data corresponding to the similarity is outputted as the retrieval result (see FIG. 16 to FIG. 18). Therefore, the type of feature applied to calculate the similarity is correctly selected without mistaking thereby the retrieval accuracy can be improved.

Additionally according to the present embodiment, the presence or absence of the compatibility between the type of the feature determined to be compatible with the key image 200 and each image data targeted for the retrieval is determined, the image data determined no to be compatible is excluded from the retrieval target, each data determined to be compatible is narrowed down to the retrieval target, and the similarity between the key image 200 and each image data of the retrieval target is calculated using the feature value of its type. Therefore, the retrieval target is narrowed down thereby further the retrieval accuracy and also the retrieval efficiency can be improved.

It is to be understood that the present invention is not intended to be limited to the above described embodiments, and various changes may be made therein without departing from the spirit of the present invention.

For example, in the above described embodiment, the program to perform the facilities of the image retrieval apparatus 100 of FIG. 1 is recorded on the computer-readable recording medium 500 of FIG. 19, the program recorded on the recording medium 500 is read into the computer 400 and executed thereby the facilities of the image retrieval apparatus may be achieved.

The computer 400 is composed of the CPU (Central Processing Unit) 410 to execute the program, the input apparatus 420 such as a keyboard and a mouse, the ROM (Read Only Memory) 430 to store various data, the RAM (Random Access Memory) 440 to store such as operation parameters, the reader 450 to read the program from the recording medium 500, the output device 460 such as a display and a printer, and the bus 470 to connect each units.

The CPU 410 reads the program stored in the recording medium 500 via the reader 450, and then executes the program so that the facilities of the image retrieval apparatus 100 is achieved. The recording medium 500 is such as an optical disk, a flexible disk and a hard disk.

Additionally, in the present embodiment, if a plurality of types of feature (color layout feature, texture feature and shape feature) are determined to be compatible by the compatibility determining unit 104, the result by integrating the similarity calculated for each type in the similarity calculating unit 105 may be determined as the similarity calculation result.

Accordingly, if a plurality of types are determined to be compatible, since the result by integrating the similarity calculated for each type is as the similarity calculation result, the retrieval accuracy can be improved in terms of the comprehensive viewpoint.

Additionally, in the present embodiment, if a plurality of types of feature (color layout feature, texture feature and shape feature) are determined to be compatible by the compatibility determining unit 104, one type among the types is selected by users and the similarity between the key image data 200 and each image data targeted for the retrieval may be calculated by the similarity calculating unit 105 using the user selected type of the feature value.

Further, in the present embodiment, the determination result of the similarity by the similarity determining unit 104 is approved by users, and the similarity between the key image data 200 and each image data targeted for the retrieval may be calculated by the similarity calculating unit 105 based on the determination result approved by users.

Accordingly, users can be received support to select the optimum type of the feature and the user interface for the image retrieval can be improved.

As thus described above, according to the present invention, for each type of the feature extracted from the key image, the presence or absence of the compatibility is determined based on whether the similarity fitted to the human's feeling regarding a similarity is calculated, the similarity between the key image and each image targeted for the retrieval is calculated according to the determined result, and the image data corresponding to the similarity is outputted as the retrieval result. Therefore, the type of feature applied to calculate the similarity is correctly selected without mistaking thereby the retrieval accuracy can be improved.

Additionally according to the present invention, the presence or absence of the compatibility between the type of the feature determined to be compatible with the key image and each image targeted for the retrieval is determined, the image determined no to be compatible is excluded from the retrieval target, each image determined to be compatible is narrowed down to the retrieval target, and the similarity between the key image and each image of the retrieval target is calculated using the feature value of its type. Therefore, the retrieval target is narrowed down thereby further the retrieval accuracy and also the retrieval efficiency can be improved.

Additionally according to the present invention, if a plurality of types of feature is determined to be compatible, the result by integrating the similarity calculated for each type is as the similarity calculation result. Therefore the retrieval accuracy can be improved in terms of the comprehensive viewpoint.

Additionally, in the present invention, if a plurality of types of feature are determined to be compatible, one type among the types is selected by users and the similarity between the key image and each image targeted for the retrieval is calculated using the user selected type of the feature. Therefore users can be received support to select the optimum type of the feature and the user interface for the image retrieval can be improved.

Further, according to the present invention, the determination result of the similarity is approved by users, and the similarity between the key image and each image targeted for the retrieval is calculated based on the determination result approved by users. Therefore users can be received support to select the optimum type of the feature and the user interface for the image retrieval can be improved.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A computer-readable recording medium that stores a computer program that causes a computer to execute:
extracting a plurality of feature values from a key image;
determining presence or absence of a compatibility for each of feature types of the feature values based on whether a similarity that matches with feelings of humans about similarity can be calculated for each of the feature types;
calculating a similarity between the key image and each of a plurality of target images based on a determination result obtained at the determining; and
selecting and outputting a target image from among the target images that matches with the similarity calculated at the calculating.

2. The computer-readable recording medium according to claim 1, wherein the determining includes determining the presence or absence of the compatibility between the feature type determined to be compatible with the key image and each image targeted for the retrieval,
wherein the calculating includes excluding from calculation of the similarity target images that are determined to be not compatible.

3. The computer-readable recording medium according to claim 1, wherein if more than one feature types are determined to be compatible at the determining, then the calculating includes calculating the similarity as an integrated value of the similarity of respective feature type that is determined to be compatible.

4. The computer-readable recording medium according to claim 1, wherein if more than one feature types are determined to be compatible at the determining, then
the determining includes making a user select a feature type from among the feature types that are determined to be compatible, and
the calculating includes calculating a similarity between the key image and each of a plurality of target images based on a feature value of the feature type selected by the user.

5. The computer-readable recording medium according to claim 1, wherein the determining includes making the user approve the determination result obtained, and
calculating includes calculating a similarity between the key image and each of the target images based on the determination result approved by the user.

6. An image retrieval method comprising:
extracting a plurality of feature values from a key image;
determining presence or absence of a compatibility for each of feature types of the feature values based on whether a similarity that matches with feelings of humans about similarity can be calculated for each of the feature types;
calculating a similarity between the key image and each of a plurality of target images based on a determination result obtained at the determining; and
selecting and outputting a target image from among the target images that matches with the similarity calculated at the calculating.

7. The image retrieval method according to claim 6, wherein the determining includes determining the presence or absence of the compatibility between the feature type determined to be compatible with the key image and each image targeted for the retrieval,
wherein the calculating includes excluding from calculation of the similarity target images that are determined to be not compatible.

8. The image retrieval method according to claim 6, wherein if more than one feature types are determined to be compatible at the determining, then the calculating includes calculating the similarity as an integrated value of the similarity of respective feature type that is determined to be compatible.

9. The image retrieval method according to claim 6, wherein if more than one feature types are determined to be compatible at the determining, then
the determining includes making a user select a feature type from among the feature types that are determined to be compatible, and
the calculating includes calculating a similarity between the key image and each of a plurality of target images based on a feature value of the feature type selected by the user.

10. The image retrieval method according to claim 6, wherein the determining includes making the user approve the determination result obtained, and
calculating includes calculating a similarity between the key image and each of the target images based on the determination result approved by the user.

11. An image retrieval apparatus comprising:
an extracting unit that extracts a plurality of feature values from a key image;
a determining unit that determines presence or absence of a compatibility for each of feature types of the feature values based on whether a similarity that matches with feelings of humans about similarity can be calculated for each of the feature types;
a calculating unit that calculates a similarity between the key image and each of a plurality of target images based on a determination result obtained by the determining unit; and
a selecting and outputting unit that selects and outputs a target image from among the target images that matches with the similarity calculated by the calculating unit.

12. The image retrieval apparatus according to claim 11, wherein the determining unit determines the presence or absence of the compatibility between the feature type determined to be compatible with the key image and each image targeted for the retrieval,
wherein the calculating unit excludes from calculation of the similarity target images that are determined to be not compatible.

13. The image retrieval apparatus according to claim 11, wherein if more than one feature types are determined to be compatible by the determining unit, then the calculating unit calculates the similarity as an integrated value of the similarity of respective feature type that is determined to be compatible.

14. The image retrieval apparatus according to claim 11, wherein if more than one feature types are determined to be compatible by the determining unit, then
the determining unit makes a user select a feature type from among the feature types that are determined to be compatible, and
the calculating unit calculates a similarity between the key image and each of a plurality of target images based on a feature value of the feature type selected by the user.

15. The image retrieval apparatus according to claim 11, wherein the determining includes making the user approve the determination result obtained, and
calculating includes calculating a similarity between the key image and each of the target images based on the determination result approved by the user.
